(19) United States
(12) Patent Application Publication
(10) Pub. No.: US 2015/0101371 A1
(43) Pub. Date: Apr. 16, 2015

(54) Key Mechanism

(71) Applicant: Kin Kei Hardware Industries Limited, Hong Kong (HK)

(72) Inventors: Jian Hua Yi, Hunan Province (CN); Ming Chen, Guangdong Province (CN)

(73) Assignee: Kin Kei Hardware Industries Limited, Hong Kong (HK)

(21) Appl. No.: 14/053,510

(22) Filed: Oct. 14, 2013

(51) Int. Cl. E05B 19/00; E05B 37/00

(52) U.S. Cl. CPC E05B 19/0011; E05B 19/0017; E05B 37/00
USPC 70/382

(57) ABSTRACT

A key mechanism comprises a rack and an external force key member, the lower part of the rack disposed with a transmission pinion on one side and ratchet means on the other side. The ratchet means comprises a first ratchet and a second ratchet arranged consecutively to one another from the top down. The rack is provided with a first step and a second step arranged consecutively to one another from the top down. An elastic retaining member is mounted on the ratchet-side of the rack, and a rack returning spring and key returning spring are respectively mounted on the rack and the external force key member. The elastic retaining member is brought into clamp connection with the first or second ratchet in the lower part under the press action on the external force key member. The key mechanism increases the range of possible password settings of the code lock.

### FIELD OF THE INVENTION

The present invention relates to the technical field of code locks. Specifically, the present invention relates to the technology of key mechanisms for use in code locks.

### BACKGROUND OF THE INVENTION

In existing key-type code locks, each key mechanism for a password can usually only be pressed once when setting a desired password. This limits the range of possible password settings of the code lock. As a result, the number of keys and key mechanisms must be increased to enlarge the range of possible password settings of the code lock. This increases the cost and size of the code lock, which is undesirable.

### SUMMARY OF THE INVENTION

The objective of the present invention is to provide a key mechanism with simple structure, low cost and convenience for use in a key-type code lock. This key mechanism is also capable of increasing the range of possible password settings of the code lock.

The present invention is achieved through the following technical solution, which is in accordance with claim 1.

Accordingly a key mechanism is provided, which comprises a rack and an external force key member; the lower part of the rack is disposed with a transmission pinion on one side and ratchet means on the other side; the ratchet means is comprised of a first ratchet and a second ratchet arranged consecutively to one another from the top down; the rack is provided with a first step and a second step arranged consecutively to one another from the top down; an elastic retaining member is positioned on the ratchet-side of the rack; and a rack returning spring and a key returning spring are mounted on the rack and the external force key member respectively; wherein the elastic retaining member can be brought into clamp connection with the first ratchet or the second ratchet in the lower part of the rack under the press action on the external force key member.

At the middle of the lower part of the rack, a guide sliding opening is arranged between the transmission pinion and the ratchet means of the rack; a first step and a second step are arranged on the top of the rack; a top surface on the top of the transmission pinion is molded into a first step surface; each ratchet of the rack is provided with a tooth tip, a tooth plane and a tooth inclined plane, of which the tooth plane is on the top, while the tooth inclined plane is on the bottom and it is along the direction perpendicular to the length of the rack.

The elastic retaining member is arranged with an inclined plane part and a part for plane connection, wherein the first ratchet or the second ratchet can form a clamp connection with the elastic retaining member through the part for plane connection.

Compared with the prior art, embodiments of the present invention have the following advantageous effects: the key mechanism can be pressed twice through the technical solution of the present invention. When the external force key member and the rack with two-stage teeth are completely reset, a finger on the lower end of the external force key member abuts with the first step of the rack. When the key is pressed down a distance, the ratchet means on the right of the rack gets clamped by the elastic retaining member where a first action is finished on the key. The external force key member will return to its original position under the action of the key returning spring when it is released. At this moment, the finger of the external force key member automatically (this may be as a result of an appropriate biasing of the finger) inserts into the second step of the rack. As a result, when the key is pressed down once again, the finger of the external force key member can press against the second step of the rack and thereby press down the rack altogether until it is clamped by the elastic retaining member to finish a second action on the key. It can be seen from this that when the key mechanism of the present invention is mounted within a code lock, it can increase the range of possible password settings of the code lock by enabling the same key to be used twice in a password, and it is simple in structure, low in cost as well as convenient in usage.

### BRIEF DESCRIPTION OF THE DRAWINGS

FIG. 1 is a structural diagram for the key mechanism according to an embodiment of the present invention;

FIG. 2 is a structural diagram for the rack of the key mechanism according to an embodiment of the present invention;

FIG. 3 is a structural diagram for the elastic retaining member of the key mechanism according to an embodiment of the present invention;

FIG. 4 is a state diagram for the key mechanism when the key mechanism resets completely, according to an embodiment of the present invention;

FIG. 5 is a state diagram for the key mechanism when a first action is finished on the key, according to an embodiment of the present invention;

FIG. 6 is a state diagram for the key mechanism when the key returning spring resets, according to an embodiment of the present invention;

FIG. 7 is a state diagram for the key mechanism when a second action is finished on the key, according to an embodiment of the present invention; and

FIG. 8 is a state diagram for the key mechanism when the key resets, according to an embodiment of the present invention.

### DETAILED DESCRIPTION OF SPECIFIC EMBODIMENTS

The key mechanism of the present invention will be further described in detail with reference to accompanying drawings in the following.

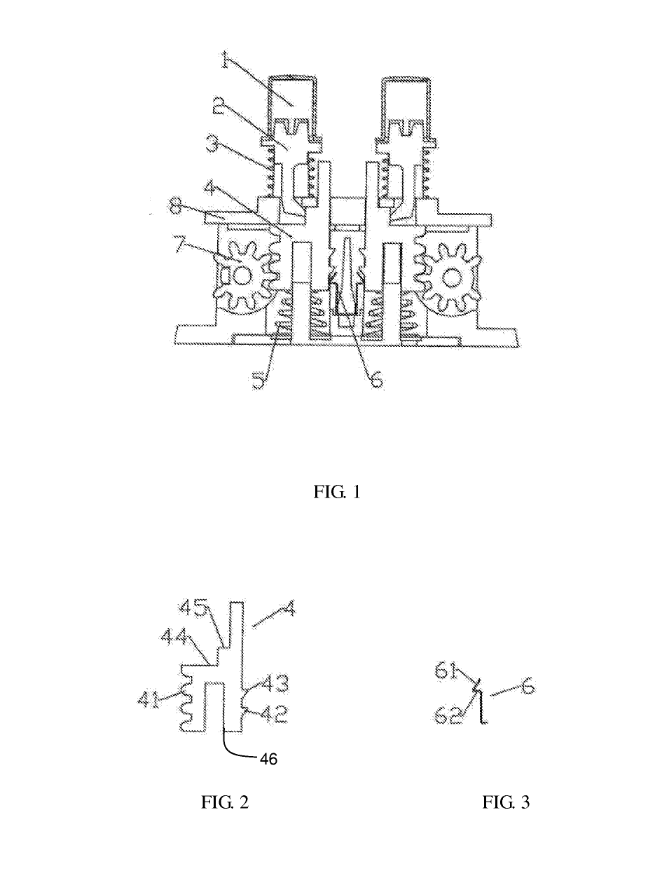

As shown in FIGS. 1-3, a key mechanism according to an embodiment of the present invention comprises a rack 4 and an external force key member 2. A key button 1 is mounted above the external force key member 2, and the lower part of the rack 4 is disposed with a transmission pinion 41 on one side and ratchet means on the other side. The ratchet means is comprised of a first ratchet 42 and a second ratchet 43 arranged consecutively to one another from the top down, and the top of the rack 4 is provided with a first step 44 and a second step 45 arranged consecutively to one another from the top down. An elastic retaining member 6 is positioned on the ratchet-side of the rack. Moreover, a rack returning spring 5 as well as a key returning spring 3 are respectively mounted on the rack 4 and the external force key member 2. The elastic retaining member 6 can be brought into clamp connection with the first ratchet 42 or the second ratchet 43 in the lower part of the rack 4 under the press action on the external force key member 2. The transmission pinion 41 further engages a gear 7. The gear 7 functions as password transformation. That is, when the key button 1 is pressed, the rack 4 is driven to be clamped with the gear 7 so that the password key pressed down is locked. Each component of the key mechanism is supported within a main body of the code lock.

At the middle of the lower part of the rack 4, a guide sliding opening 46 is arranged between the transmission pinion and the ratchet means of the rack. The first step 44 and the second step 45 are arranged on the top of the rack. A top surface on the top of the transmission pinion 41 is molded into a first step surface 44. Each ratchet of the rack is provided with a tooth tip, a tooth plane and a tooth inclined plane, of which the tooth plane is on the top, while the tooth inclined plane is on the bottom and it is along the direction perpendicular to the length of the rack. The elastic retaining member 6 is arranged with an inclined plane part 61 and a part for plane connection 62, wherein the first ratchet 42 or the second ratchet 43 can form a clamp connection with the elastic retaining member 6 through the part for plane connection 62.

The key mechanism according to an embodiment of the present invention can be pressed twice during usage. The two-stage rack and two-stage limiting structure are employed so that the key mechanism can be pressed twice for setting passwords that use the same key twice.

The operating principle for embodiments of the present invention is as follows:

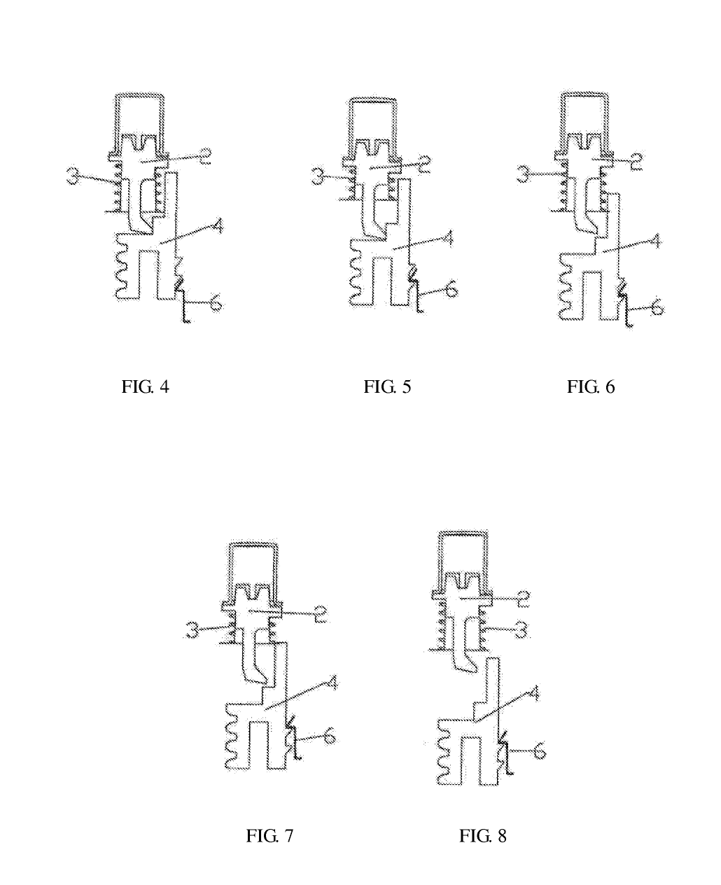

(1) when the external force key member 2 and the two-stage rack are completely reset, the external force key member 2 abuts with the first step 44 of the rack (as shown in FIG. 4). When the key is pressed down for a distance, the ratchet means on the right of the two-stage rack gets clamped by the elastic retaining member 6 (as shown in FIG. 5) where a first action is finished on the key.

(2) The external force key member 2 will reset under the action of the key returning spring 3 when it is released; at this moment, the finger of the external force key member automatically inserts into the second step 45 of the two-stage rack (as shown in FIG. 6).

(3) When the key is pressed down once again, the external force key member 2 can press against the second step 45 of the two-stage rack to press the two-stage rack down altogether until it is clamped by the elastic retaining member 6 (as shown in FIG. 7). In this case, a second action is finished on the key.

(4) Finally, the key resets as shown in FIG. 8. The two-stage rack mentioned above refers to the rack 4.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A key mechanism for use in a key-type code lock, the key mechanism comprising:
a rack and an external force key member;
a lower part of the rack is disposed with a transmission pinion on a first side and ratchet means on a second side;
the ratchet means comprising a first ratchet and a second ratchet arranged consecutively to one another from the top down;
the rack is provided with a first step and a second step arranged consecutively to one another from the top down;
an elastic retaining member is positioned on the second side of the rack;
a rack returning spring and a key returning spring are mounted on the rack and the external force key member respectively;
wherein the elastic retaining member is brought into clamp connection with the first ratchet or the second ratchet in the lower part of the rack under a press action on the external force key member.

2. The key mechanism of claim 1, wherein
at a middle of the lower part of the rack, a guide sliding opening is arranged between the transmission pinion and the ratchet means of the rack;
the first step and the second step are arranged at a top of the rack, the first step having a first step surface;
a top surface on a top of the transmission pinion is molded into the first step surface of the first step;
each ratchet of the rack is provided with a tooth tip, a tooth plane and a tooth inclined plane, of which the tooth plane is on the top, while the tooth inclined plane is on the bottom and along a direction perpendicular to a length of the rack.

3. The key mechanism of claim 1, wherein the elastic retaining member is arranged with an inclined plane part and a part for plane connection, wherein the first ratchet or the second ratchet forms a clamp connection with the elastic retaining member through the part for plane connection.

4. The key mechanism of claim 2, wherein the elastic retaining member is arranged with an inclined plane part and a part for plane connection, wherein the first ratchet or the second ratchet forms a clamp connection with the elastic retaining member through the part for plane connection.
